(19) United States
(12) Patent Application Publication
(10) Pub. No.: US 2013/0239806 A1
(43) Pub. Date: Sep. 19, 2013

(54) Reduction of Particulates in Gas Streams

(71) Applicants: Ronald R. Landreth, Baton Rouge, LA (US); Sidney G. Nelson, JR., Hudson, OH (US)

(72) Inventors: Ronald R. Landreth, Baton Rouge, LA (US); Sidney G. Nelson, JR., Hudson, OH (US)

(73) Assignee: ALBEMARLE CORPORATION, Baton Rouge, LA (US)

(21) Appl. No.: 13/810,244

(22) PCT Filed: Jul. 6, 2011
(86) PCT No.: PCT/US11/43026

§ 371 Date: May 28, 2013

Related U.S. Application Data
(60) Provisional application No. 61/365,029, filed on Jul. 16, 2010.

(51) Int. Cl. B03C 3/013

(52) U.S. Cl. CPC B03C 3/013
USPC 95/58

(57) ABSTRACT

This invention provides methods for reducing a spark rate and/or increasing the voltage in a cold-side electrostatic precipitator through which a particulate-containing gas stream is directed, wherein said electrostatic precipitator has a spark rate and a voltage. The methods comprise injecting an amount of a halogenated carbonaceous substrate formed from a carbonaceous substrate and an elemental halogen and/or a hydrohalic acid into the particulate-containing gas stream upstream of the electrostatic precipitator, such that the spark rate decreases by about 40% or more and/or such that the voltage can be increased by about 20% or more than when said halogenated carbonaceous substrate is not injected.

### STATEMENT REGARDING FEDERALLY SPONSORED RESEARCH

The work leading to the invention described in this patent application was made with Government support under Contract No. DE-FC26-05NT42308 awarded by the Department of Energy, National Energy Technology Laboratory. The Government may have certain rights in this invention.

### TECHNICAL FIELD

This invention relates to the reduction of the spark rate in electrostatic precipitators through which particulate-containing gas streams are directed.

### BACKGROUND OF THE INVENTION

There are environmental concerns regarding particulate emissions. Electrostatic precipitators are commonly used to decrease particulate emissions from particulate-containing gas streams by collecting at least some of the particulates from the gas stream. A particular concern is the emission of particulates from combustion sources such as power plants. Emissions from power plants are regulated in the United States by Federal, state, and, in some instances, local governments. Environmental concerns regarding particulate emissions from combustion, especially combustion of coal, are well known.

As just mentioned, one way of reducing particulate emissions is by use of an electrostatic precipitator. An electrostatic precipitator (ESP) has at least one pair of oppositely charged electrodes or plates, which create an electric field through which a particulate-containing gas stream is passed; usually a series of electrodes and plates is employed. Charged particles in the gas stream collect on oppositely-charged electrodes or plates. The collected particles are periodically removed from the electrodes or plates by vibrating the electrodes or plates, either physically (e.g., by rapping or striking) or by sonic means (e.g., sonic horn blasts).

An electrostatic precipitator is operated at a high voltage to create a strong electric field. The stronger the electric field, the greater the amount of particulates that are ionized and then collected on the collector plates of the ESP. Thus, an electrostatic precipitator is preferably operated at the highest electric field (highest voltage) practical. ESPs are typically operated in such a manner that the input power is ramped until there is a spark generated on the collection plate, or a preset maximum power input is reached. Operation in this manner provides the maximum amount of power input and typically results in the highest particulate collection efficiency, which in turn decreases the particulate emissions from the gas stream.

When employed to remove particulates from a combustion gas stream, the ESP can be either upstream of the air heater or downstream of the air heater. An ESP that is upstream of the air heater is often called a hot side electrostatic precipitator, and typically operates in environments where the temperatures are above about 400° F. (204° C.). An ESP that is downstream of the air heater is often called a cold side electrostatic precipitator, and typically operates in environments where the temperatures are below about 400° F. (204° C.).

The effect of brominated carbonaceous substrates on ESP collection efficiency was first observed in a trial conducted at a coal-burning power plant in a unit which had a cold-side ESP operating at 320° F. (160° C.). Only opacity was monitored, not the particulate matter emissions. A reduction in the opacity of the exiting gas was observed; in particular, the opacity was held to an average of 21% during the trial by injecting a brominated carbonaceous substrate but no SO₃. Typically, during comparative periods, 20% to 30% opacity was measured in this system with SO₃ added. See in this connection R Landreth et. al., Brominated Sorbents for Small Cold-Side ESPs, Hot-Side ESPs, and Fly Ash Use in Concrete; DOE/NETL Mercury Control Technology Conference, Pittsburgh, Pa., December 2007.

One of the factors affecting the collection efficiency of electrostatic precipitators is the resistivity of the particulates that are being collected. A buildup of particulates having high resistivity on collection plates of ESPs presents performance problems. One such problem, sometimes referred to as “back-corona” discharge, is a spark or arc across the electric field resulting from a voltage gradient build-up across the particulate layer on the collection plate. If the voltage becomes too large because of high resistivity of the particulate layer, gas trapped in this particulate layer can ionize and cause a spark. Every time this occurs, a “puff” of particulates is released from the collection plate(s), and the puff increases the particulate emissions in the exiting gas stream, which is observed as an increase in gas opacity. An increased spark rate requires a decrease in the applied voltage, which in turn decreases the collection efficiency of the ESP.

To enhance particulate collection by an ESP, one or more conditioning agents can be added to the particulate-containing gas stream upstream of the ESP to increase the susceptibility of the particulates to collection by an ESP. Generally, the conditioning agents are believed to alter the resistivity of the particulates in the gas stream. The use of conditioning agents allows increased voltage during operation of the ESP and therefore increased collection efficiency of the ESP.

One such conditioning agent is SO₃. While beneficial to particulate collection by an ESP, SO₃ has been observed to have a significant negative impact on mercury sorbent effectiveness. To counteract this negative effect of SO₃, magnesium or calcium sorbents may be injected into a flue gas stream at an appropriate point to remove the SO₃. However, these magnesium and calcium sorbents increase the resistivity of fly ash in the flue gas, which in turn negatively affects the collection of particulates by the electrostatic precipitators. In addition, use of SO₃ can increase sulfur emissions.

Sulphuric or phosphoric acids can also be used as conditioning agents to enhance particulate collection. Due to the hazardous nature of these acids, special equipment and handling is necessary unless the acids are adsorbed onto an inert particulate support (e.g., calcium silicate, diatomaceous earth, vermiculite, magnesium silicate sodium montmorillonite or carbon black). Other flue gas conditioning agents for control of particulate, NOₓ, and SOₓ emissions include ammonia and ammonium compounds such as ammonium sulfate and ammonium phosphate, sodium bisulfate and sodium phosphate. These conditioning agents generally must be added with careful control, may foul downstream equipment, and/or are undesirable emission components in a gas stream.

It would be desirable to increase particulate collection efficiency of an ESP, especially without need for conditioning agents that increase undesirable emissions or require narrow operating conditions.

### SUMMARY OF THE INVENTION

This invention provides methods for the reduction of particulate emissions in gas streams, including combustion gas streams. These methods increase the collection efficiency of electrostatic precipitators (ESPs), particularly cold-side ESPs, by allowing for greater voltages without appreciably increasing the resistivity of the particulate layer on the collection plate and/or without increasing the spark rate in the electrostatic precipitator (ESP). Surprisingly, this is accomplished without the addition of conditioning agents, especially those requiring narrow conditions, or that have their own emissions drawbacks, but rather with a material that can be injected into the particulate-containing gas stream, even when the gas stream is a hot, particulate-containing combustion gas. In particular, the methods described herein can be used successfully in the absence of an injection of SO₃ into the particulate-containing gas stream; thus, another benefit of the methods of this invention is decreased corrosion of system components.

An embodiment of this invention is a method for reducing a spark rate and/or increasing the voltage in a cold-side electrostatic precipitator through which a particulate-containing gas stream is directed, wherein said electrostatic precipitator has a spark rate and a voltage. The method comprises injecting an amount of a halogenated carbonaceous substrate formed from a carbonaceous substrate and an elemental halogen and/or a hydrohalic acid into the particulate-containing gas stream upstream of the electrostatic precipitator, such that the spark rate decreases by about 40% or more and/or such that the voltage can be increased by about 20% or more than when said halogenated carbonaceous substrate is not injected.

### BRIEF DESCRIPTION OF THE DRAWINGS

FIG. 1 is a graph of the spark rate in a cold-side ESP for the period immediately before and during the injection test of Example 1, using a brominated carbonaceous substrate.

FIG. 2 is a graph of the particulates measured at an ESP outlet over time during one of the injection tests in Example 2.

FIG. 3a is a graph of the particulates measured at an ESP outlet over time during one of the injection tests in Example 2.

FIG. 3b is a graph of the percent particulate removal over the same time period shown in FIG. 3a.

These and other embodiments and features of this invention will be still further apparent from the ensuing description and appended claims

### FURTHER DETAILED DESCRIPTION OF THE INVENTION

Throughout this document, the term “particulates” refers to small particles (generally about 20 μm or less in diameter) suspended in the gas stream. The term “gas stream”, as used throughout this document, refers to a quantity of gas that is moving in a direction. As used throughout this document, the phrase “combustion gas” refers to the gas (mixture) resulting from combustion. Flue gas is a type of combustion gas. In this connection, the term “stream” as used in “combustion gas stream” refers to a quantity of combustion gas that is moving in a direction.

One of the advantages of the methods of the invention is that the halogenated carbonaceous substrate injected into the particulate-containing gas stream is a particulate, and is also removed from the gas stream by the electrostatic precipitator along with the other particulates present in the gas stream.

The present invention is directed to cold-side electrostatic precipitators. Injecting a halogenated carbonaceous substrate into a gas stream that then travels through the electrostatic precipitator usually reduces the spark rate (decreases or prevents spark formation) in the electrostatic precipitator. Without wishing to be bound by theory, it is believed that the surface resistivity of the collected particulates is reduced, which permits greater collection efficiency in the electrostatic precipitator.

The halogenated carbonaceous substrate can be a chlorinated, brominated, or iodated carbonaceous substrate. Preferably, the halogenated carbonaceous substrate is a brominated halogenated carbonaceous substrate. Iodated carbonaceous substrates are less favored because impregnated iodine and iodine compounds are often released from carbonaceous substrates at modestly elevated temperatures. When the particulate-containing gas stream is a combustion gas stream, at the elevated temperatures typical of combustion gas streams, much of any adsorbed iodine or iodides will be released from these materials. The loading of the halogen on the carbonaceous substrate is normally such that the halogen is present in an amount of about 0.25 to about 15 wt %, preferably about 1 to about 10 wt %, and more preferably about 2.5 to about 7.5 wt % of the total weight of the halogenated carbonaceous substrate.

The halogenated carbonaceous substrate is generally formed from a halogen source and a carbonaceous substrate. The carbonaceous substrate is a carbon-based adsorbent, such as activated carbon or, preferably, fine powdered activated carbon (PAC). Suitable halogen sources include the elemental (diatomic) halogens and hydrohalic acids (hydrogen halides). Syntheses of halogenated carbonaceous substrates using elemental halogens and/or hydrohalic acids are described in U.S. Pat. No. 6,953,494. Preferred halogenated carbonaceous substrates are those formed from powdered activated carbon and bromine gas, and are commercially available (B-PAC, C-PAC, H-PAC and Q-PAC; Albemarle Corporation). When the halogenated carbonaceous substrates were formed from metal halide salts, beneficial effects (e.g., decreased sparking) were not observed.

Optionally, other agents, such as conditioning agents, can be injected if needed or desired. Preferably, no agents other than the halogenated carbonaceous substrate are added. It is preferred to practice the invention in the absence of conditioning agents. Also preferred is operation in the absence of injected SO₃, since SO₃ has been observed to decrease the effectiveness of brominated carbonaceous substrates.

The halogenated carbonaceous substrates are typically injected at a rate of about 0.5 to about 15 lb/MMacf (8×10⁻⁶ to 240×10⁻⁶ kg/m³). Preferred injection rates are about 1 to about 10 lb/MMacf (16×10⁻⁶ to 160×10⁻⁶ kg/m³); more preferred are injection rates of about 2 to about 5 lb/MMacf (32×10⁻⁶ to 80×10⁻⁶ kg/m³), though it is understood that the preferred injection rate varies with the particular system configuration.

This invention provides flexible methods that can be applied to a number of combustion gas streams and a wide range of exhaust system equipment configurations. Generally, the halogenated carbonaceous substrate can be injected at any point upstream of the electrostatic precipitator. It is recommended that the halogenated carbonaceous substrate be injected into the particulate-containing gas at a point such that the halogenated carbonaceous substrate is not exposed to temperatures above about 1100° F. (593° C.). At or above this temperature, the halogenated carbonaceous substrate tends to decompose. The preferred point(s) for injecting the halogenated carbonaceous substrate can vary, depending upon the configuration of the system. When injected, the halogenated carbonaceous substrate contacts a flowing particulate-containing gas stream, intimately mixes with the gas stream, and is separated from the gas stream in the electrostatic precipitator, along with the particulates from the gas stream.

For combustion gas streams, the halogenated carbonaceous substrate may be injected either before the gas is passed through a heat exchanger or preheater, i.e., on the so-called “hot side” of a combustion gas exhaust system, or after the gas has passed through a heat exchanger or preheater, i.e., on the “cold side” of a combustion gas exhaust system. Preferably, the halogenated carbonaceous substrate is injected on the cold side. Operating temperatures on the cold side are generally about 400° F. (204° C.) or less.

As mentioned above, injecting a halogenated carbonaceous substrate decreases the spark rate by about 40% or more and/or allows the voltage to increase by about 20% or more than when said halogenated carbonaceous substrate is not injected into the particulate-containing gas stream. Preferably, the amount of halogenated carbonaceous substrate injected is such that the spark rate decreases by about 60% or more and/or such that the voltage can increase by about 30% or more than when said halogenated carbonaceous substrate is not injected into the particulate-containing gas stream. Generally, such comparison is best made when as many variables as possible in the comparative run are the same as the conditions during the run with the halogenated carbonaceous substrate present.

A decreased spark rate in the electrostatic precipitator is desirable, as fewer puffs of particulates are released from the collection plate(s) of the electrostatic precipitator, which in turn decreases the particulate emissions in the exiting gas stream. Another advantage provided by this invention is that the voltage can be increased, which allows a stronger electric field to be generated in the electrostatic precipitator, so that greater amounts of particulates are ionized and then collected on the collector plates of the electrostatic precipitator.

When brominated carbonaceous substrates were injected into combustion gas streams, it was been observed that the opacity of the combustion gas streams, after passing through the electrostatic precipitator, decreased by about 3% or more, sometimes by about 6% or more, as compared to runs in which the brominated carbonaceous substrate was not present. The effect was observed at both low and high loads, and the increase in opacity was similar for both loads. When determining the decrease in opacity of a particulate-containing gas stream downstream of the electrostatic precipitator, such comparison is best made when as many variables as possible in the comparative run are the same as the conditions during the run with the halogenated carbonaceous substrate present.

As noted above, electrostatic precipitators are used to decrease particulate emissions from particulate-containing gas streams by collecting at least some of the particulates from the gas stream. Various industrial processes produce particulate-containing gas streams. Examples of such processes include waste incineration, metallurgical processes, metal recovery processes, combustion, and cement production. In a preferred embodiment, the particulate-containing gas stream is from a process other than combustion.

The following examples are presented for purposes of illustration, and are not intended to impose limitations on the scope of this invention.

### EXAMPLE 1

In this Example, combustion (flue) gas from a power plant unit having a 234 MW boiler fired with sub-bituminous coal was treated. The power plant unit consisted of two separate boilers (superheat and reheat) that were operated as one boiler; however, each boiler had independent ductwork and cold-side ESPs operating at 310° F. (154° C.). Each ESP had a specific collection area (SCA) of 118 ft²/1000 acfm (actual cubic feet per minute; 3.34 m³ per 472 L/sec). The stream size of each ESP was 117 MWe, and the treated gas flow was 460,000 acfm (217,120 L/sec). The flue gas traveled from the ESPs to a common stack and a common opacity monitor. The injections were conducted in the reheat boiler.

The halogenated carbonaceous substrate was a brominated activated carbon which contained about 7 wt % bromine (C-PAC, Albemarle Sorbent Technologies Corporation). The halogenated carbonaceous substrate was introduced using a sorbent injection system, after the air preheater. The injection was continuous during the test period; the injection rate was 4.6 lb/MMacf (78.3×10⁻⁶ kg/m³).

The opacity during high load operation decreased a total of 4% during the test, with the decrease beginning at the time of injection and continuing to the end of the test. Since the flue gas measured at the stack was a blend from the two boilers, this opacity reduction can be considered to be equivalent to 8% for the treated boiler. This opacity effect has been reported; see S. Nelson, Jr., et. al., Effects of Activated Carbon Injection on Particulate Collectors and Particulate Emissions; Electric Utility Environmental Conference, 2007.

Not previously reported was the effect of the injected C-PAC on the spark rate. When injection began, the spark rate dropped immediately and continued to decrease throughout the test. When testing ceased, the spark rate decreased throughout the test period and recovered to baseline (comparative) levels.

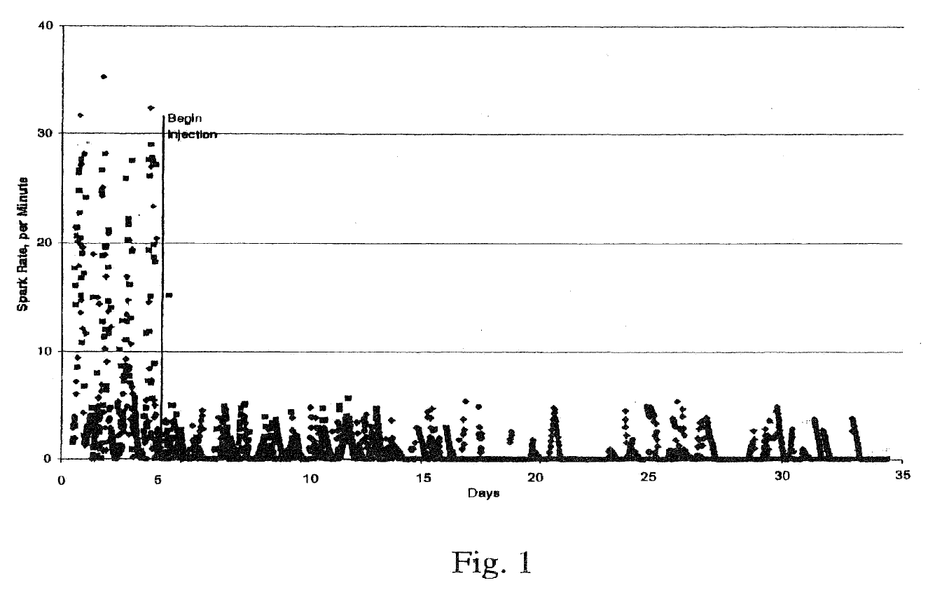

The spark rate data for the first field of the ESP during the test is presented in FIG. 1. FIG. 1 is a graph of the spark rate per minute in the front fields of the reheat boiler measured every five days for a month-long period of time. FIG. 1 shows that the spark rate in the front ESP fields was high before the beginning of the continuous injection of B-PAC (day 5). Once injection began, the spark rate immediately decreased and continued to decline throughout the trial. The reduced spark rate permitted the power (voltage) to the ESP to be increased and the collection efficiency of the ESP to improve.

### EXAMPLE 2

Two series of tests were run to evaluate the impact of different injection rates on particulate matter emissions. The power plant unit used in the series of tests in this Example was a 5000 acfm (2360 L/sec) slipstream test facility utilizing flue (combustion) gas from one of two units. Both units fire lignite coal. For these tests, the facility was equipped with two field cold-side ESPs operating at temperatures up to 345° F. (174° C.). The halogenated carbonaceous substrate was introduced using a gravimetric feeder to insure reliable and measurable flow. The power plant was equipped with online particulate matter (PM) monitors (RM320, SICK AG) to provide PM data in terms of mg/m³. The halogenated carbonaceous substrate was a brominated activated carbon which contained about 7 wt % bromine (B-PAC, Albemarle Sorbent Technologies Corporation).

For the first series of tests, an injection rate range of 0.5 to 5.3 lb/MMacf (8×10⁻⁶ to 84.9×10⁻⁶ kg/m³) was used. Injection was serial: the first injection was 0.5 MMacf (8×10⁻⁶ kg/m³); the second injection was additive so that the total amount of B-PAC added was 1.2 MMacf (19.2×10⁻⁶ kg/m³), and so forth.

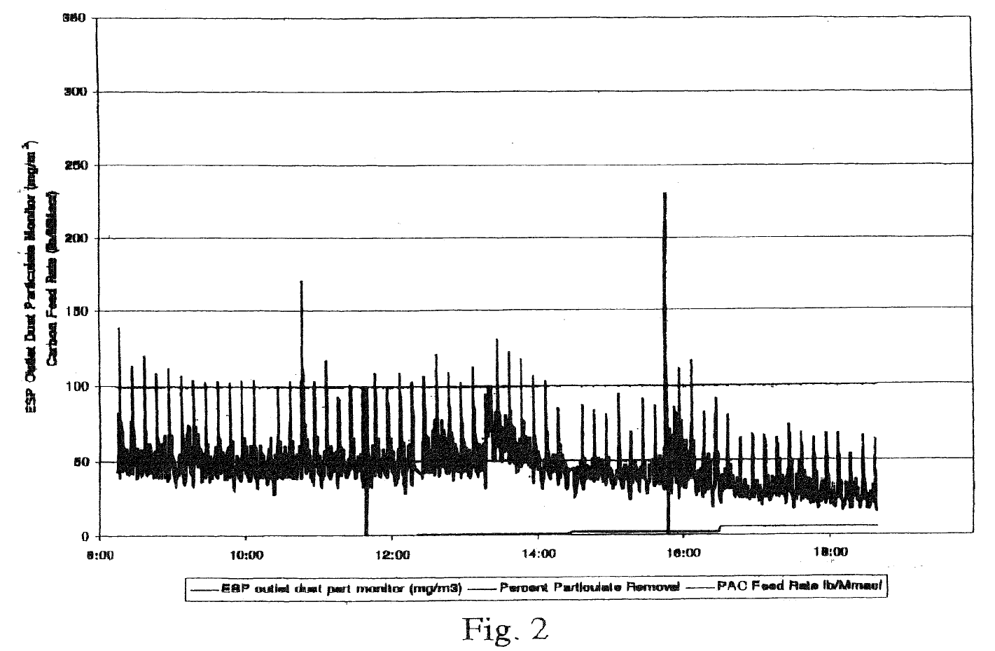

The particulate matter emission measured at the outlet was reduced by more than 50% from the value at the beginning of the test. Results are summarized in FIG. 2. FIG. 2 shows the particulates measured at the ESP outlet over time. The stepwise overlay in FIG. 2 is the amount of B-PAC injected; the nearly straight line in the graph is the percent particulate removal.

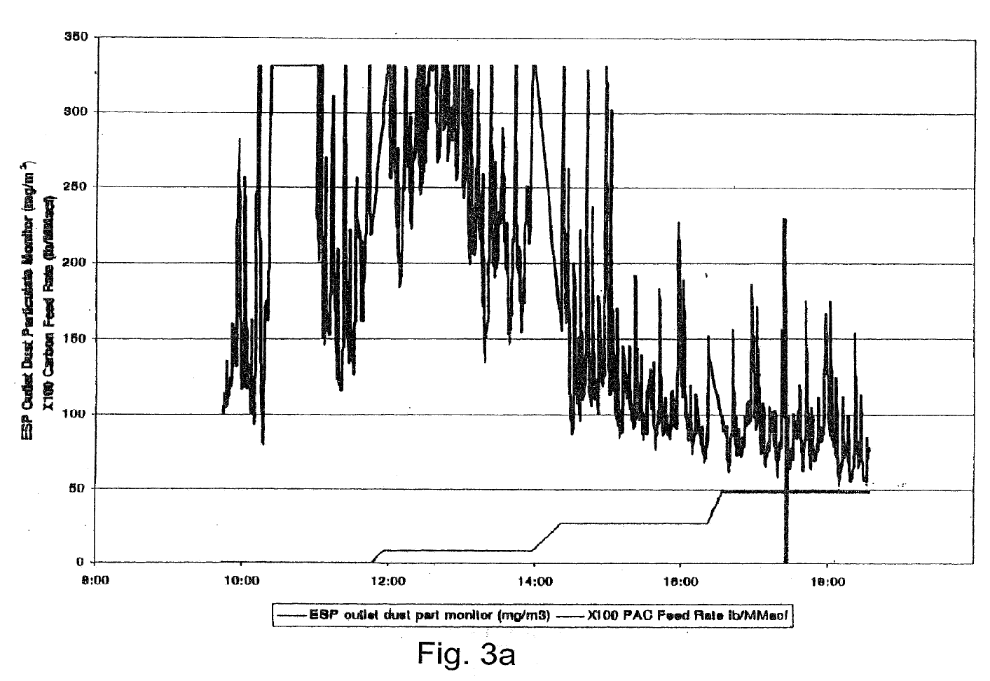

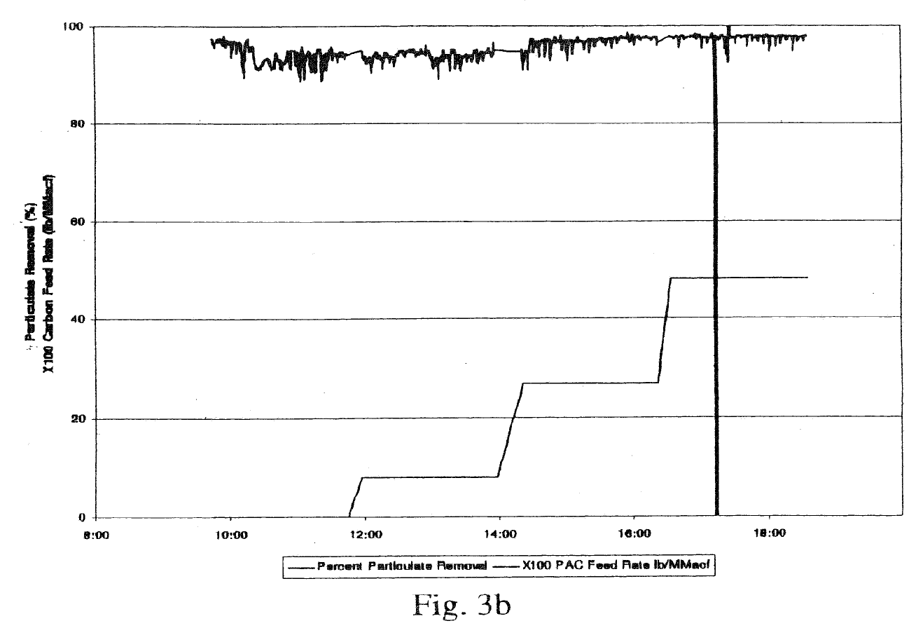

For the second run, a low injection rate was used, 0.1 to 0.5 lb/MMacf (1.60×10⁻⁶ to 8×10⁻⁶ kg/m³). Serial injection was used in the same manner as described for the first series of tests in this Example. The data show that the particulate matter emission rate was improved, even at these low injection levels. Results are summarized in FIGS. 3a-3b. FIG. 3a shows the particulates measured at the ESP outlet over time. The stepwise overlay in FIG. 3a is the amount of B-PAC injected. FIG. 3b shows the percent particulate removal over the same time period shown in FIG. 3a; the stepwise overlay in FIG. 3b is the amount of B-PAC injected.

### EXAMPLE 3

Corrosion testing was conducted for a three month time period at a power plant which has 320,000 acfm (151,040 L/sec) and a boiler with a gross capacity of 80 MW that fired medium sulfur eastern bituminous coal. The facility was equipped with a cold-side ESP operating at inlet temperatures up to 300° F. (149° C.). The ESP had an SCA of 330 ft²/1000 acfm (9.34 m³ per 472 L/sec; 3 fields) at 320° F. (160° C.).

Four test coupons made of low carbon steel were placed in the flue (combustion) gas stream in the ductwork leading to the ESP plenum. The SO₃ was injected just before (upstream) the air preheater, at an injection rate of 15 ppm throughout the test period. After the SO₃ test was completed, the coupons were removed and another four test coupons made of low carbon steel were placed in the flue gas stream at the same locations as those for the SO₃ test. Brominated powdered activated carbon (B-PAC, Albemarle Sorbent Technologies Corporation) was injected just upstream of the air preheater, at an injection rate of 8 MMacf (128×10⁻⁶ kg/m³) throughout the test period. No SO₃ was injected during the B-PAC test.

Corrosion of the test coupons by the flue gas conditioned with SO₃ was quantified by weighing the coupons after 23 days of exposure; the weight loss is reported in mg/day. The amount of corrosion of coupons by brominated PAC-conditioned flue gas was quantified by weighing the coupons after 12 days of exposure; the weight loss is reported in mg/day. The average weight loss due to corrosion of the all of the coupons exposed to each substance is also provided in Table 1. Table 1 shows that the weight loss of coupons exposed to B-PAC-containing flue gas was reduced in comparison to coupons exposed to SO₃-containing flue gas.

TABLE 1

| Sub- | | | | Sub- | | |
|---|---|---|---|---|---|---|
| stance | Days | Loss | | stance | Days | Loss |
| SO₃ | 23 | 1.674 mg/day | | B-PAC | 12 | 0.383 mg/day |
| SO₃ | 23 | 1.748 mg/day | | B-PAC | 12 | 0.367 mg/day |
| SO₃ | 23 | 2.348 mg/day | | B-PAC | 12 | 0.308 mg/day |
| SO₃ | 23 | 1.617 mg/day | | B-PAC | 12 | 0.258 mg/day |
| SO₃ | | 1.847 mg/day | aver- | B-PAC | | 0.329 mg/day |
| | | | age | | | |

The results in Table 1 clearly show that the halogenated carbonaceous substrates are significantly less corrosive than SO₃ to low carbon steel.

The methods for reducing particulate emissions from particulate-containing gas streams in the practice of this invention are not limited to the particular arrangements described in the figures. The drawings have been provided simply to illustrate common examples; variations are possible, and within the scope of this invention.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A method for reducing a spark rate and/or increasing the voltage in a cold-side electrostatic precipitator through which a particulate-containing gas stream is directed, wherein said electrostatic precipitator has a spark rate and a voltage, which method comprises injecting an amount of a halogenated carbonaceous substrate formed from a carbonaceous substrate and an elemental halogen and/or a hydrohalic acid into the particulate-containing gas stream upstream of the electrostatic precipitator, such that the spark rate decreases by about 40% or more and/or such that the voltage can be increased by about 20% or more than when said halogenated carbonaceous substrate is not injected, as compared to said cold-side electrostatic precipitator when halogenated carbonaceous substrate is not injected into the particulate-containing gas stream.

2. A method as in claim 1 wherein the spark rate decreases by about 60% or more and/or such that the voltage can be increased by about 30% or more.

3. A method as in claim 1 wherein the halogenated carbonaceous substrate is a brominated carbonaceous substrate.

4. A method as in claim 1 wherein the carbonaceous substrate is activated carbon.

5. A method as in claim 3 wherein the brominated carbonaceous substrate is a brominated activated carbon.

6. A method as in claim 1 wherein the method is carried out in the absence of injected SO₃ or in the absence of conditioning agents.

7. A method as in claim 1 wherein the method is carried out in the absence of other agents.

8. A method as in claim 1 wherein the gas stream is a combustion gas stream, and wherein the halogenated carbonaceous substrate is injected into the gas stream before the gas stream before passes through a heat exchanger.

9. A method as in claim 1 wherein the gas stream is a combustion gas stream, and wherein the halogenated carbonaceous substrate is injected into the gas stream after the gas stream passes through a heat exchanger.

10. A method as in claim 1 wherein said amount of halogenated carbonaceous substrate is about 0.5 to about 15 lb/MMacf.

11. A method as in claim 1 wherein particulate-containing gas stream is from waste incineration, metallurgical processes, metal recovery processes, or cement production.

12. A method as in claim 1 wherein the particulate-containing gas stream is from a process other than combustion.

13. A method as in claim 5 wherein the method is carried out in the absence of injected SO₃ or in the absence of conditioning agents.

14. A method as in claim 5 wherein the method is carried out in the absence of other agents.
